(19) United States
(12) Patent Application Publication
(10) Pub. No.: US 2026/0214711 A1
(43) Pub. Date: Jul. 23, 2026

(54) CHANNEL OCCUPANCY TIME SHARING ELIGIBILITY DETERMINATION

(71) Applicant: QUALCOMM Incorporated, San Diego, CA (US)

(72) Inventors: Chih-Hao LIU, San Diego, CA (US); Giovanni CHISCI, San Diego, CA (US); Jing SUN, San Diego, CA (US); Stelios STEFANATOS, San Diego, CA (US); Qing LI, Princeton Junction, NJ (US)

(21) Appl. No.: 19/139,171

(22) PCT Filed: Oct. 5, 2023
(86) PCT No.: PCT/US2023/076105

§ 371 Date: Jun. 13, 2025

(30) Foreign Application Priority Data
Feb. 13, 2023 (GR) 20230100110

(51) Int. Cl. H04W 74/0816; H04W 56/00; H04W 72/0446; H04W 92/18

(52) U.S. Cl. CPC H04W 74/0816; H04W 56/0015; H04W 72/0446; H04W 92/18

(57) ABSTRACT

Various aspects of the present disclosure generally relate to wireless communication. In some aspects, a first user equipment (UE) may receive channel occupancy time (COT) system information associated with a COT from a COT initiator. The UE may transmit a physical sidelink feedback channel communication on a channel during the COT based at least in part on a determination that the first UE is COT-sharing eligible based at least in part on a sidelink logical identifier indicated in the COT system information. Numerous other aspects are described.

### CROSS-REFERENCE TO RELATED APPLICATION

This Patent Application claims priority to Greece Patent Appl. No. 20230100110, filed on Feb. 13, 2023, entitled “CHANNEL OCCUPANCY TIME SHARING ELIGIBILITY DETERMINATION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for determining channel occupancy time sharing eligibility.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

A first user equipment (UE) may communicate with a second UE over a sidelink. The first UE may determine whether the channel for the sidelink is clear. If the first UE determines that a channel is clear, the first UE may treat the channel as clear for a maximum duration of time, or a channel occupancy time (COT). If the first UE does not need to use the whole COT for transmission or reception, the first UE may share the COT with the second UE. The first UE may provide COT system information (COT-SI) that indicates the COT. However, there are scenarios where the second UE is not able to clearly determine whether the second UE is eligible to share the COT.

According to various aspects described herein, the second UE may receive COT-SI from the first UE, which initiates the COT, and transmit a physical sidelink feedback channel (PSFCH) communication during the COT based at least in part on a sidelink logical identifier (ID) indicated in the COT-SI. The second UE may match the sidelink logical ID with a logical ID in a physical sidelink shared channel (PSSCH) communication from the first UE to determine if the second UE is eligible to share the COT (COT-sharing eligible). The logical ID may be a destination ID, a source ID, or a groupcast ID. In some aspects, the second UE may determine that the second UE is COT sharing eligible if the PSFCH communication follows a data transmission in the time domain within a transmission burst that targets the first UE. Successfully using the COT reduces communication latency.

Some aspects described herein relate to a method of wireless communication performed by a first UE. The method may include receiving COT-SI associated with a COT from a COT initiator. The method may include transmitting a PSFCH communication on a channel during the COT based at least in part on a determination that the first UE is COT-sharing eligible based at least in part on a sidelink logical ID indicated in the COT-SI.

Some aspects described herein relate to a method of wireless communication performed by a second UE. The method may include selecting a first UE that is eligible for COT sharing. The method may include transmitting COT-SI that includes a sidelink logical ID that is associated with the first UE.

Some aspects described herein relate to a first UE for wireless communication. The first UE may include one or more memories and one or more processors coupled to the one or more memories. The one or more processors may be configured to receive COT-SI associated with a COT from a COT initiator. The one or more processors may be configured to transmit a PSFCH communication on a channel during the COT based at least in part on a determination that the first UE is COT-sharing eligible based at least in part on a sidelink logical ID indicated in the COT-SI.

Some aspects described herein relate to a second UE for wireless communication. The second UE may include one or more memories and one or more processors coupled to the one or more memories. The one or more processors may be configured to select a first UE that is eligible for COT sharing. The one or more processors may be configured to transmit COT-SI (associated with a COT) that includes a sidelink logical ID that is associated with the first UE.

Some aspects described herein relate to a non-transitory computer-readable medium that stores a set of instructions for wireless communication by a first UE. The set of instructions, when executed by one or more processors of the first UE, may cause the first UE to receive COT-SI associated with a COT from a COT initiator. The set of instructions, when executed by one or more processors of the first UE, may cause the first UE to transmit a PSFCH communication on a channel during the COT based at least in part on a determination that the first UE is COT-sharing eligible based at least in part on a sidelink logical ID indicated in the COT-SI.

Some aspects described herein relate to a non-transitory computer-readable medium that stores a set of instructions for wireless communication by a second UE. The set of instructions, when executed by one or more processors of the second UE, may cause the second UE to select a first UE that is eligible for COT sharing. The set of instructions, when executed by one or more processors of the second UE, may cause the second UE to transmit COT-SI, associated with a COT, that includes a sidelink logical ID that is associated with the first UE.

Some aspects described herein relate to an apparatus for wireless communication. The apparatus may include means for receiving COT-SI associated with a COT from a COT initiator. The apparatus may include means for transmitting a PSFCH communication on a channel during the COT based at least in part on a determination that the apparatus is COT-sharing eligible based at least in part on a sidelink logical ID indicated in the COT-SI.

Some aspects described herein relate to an apparatus for wireless communication. The apparatus may include means for selecting a first UE that is eligible for COT sharing. The apparatus may include means for transmitting COT-SI that includes a sidelink logical ID that is associated with the first UE.

Aspects generally include a method, apparatus, system, computer program product, non-transitory computer-readable medium, UE, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating an example of selecting sidelink resources, in accordance with the present disclosure.

FIG. 6 is a diagram illustrating an example associated with channel occupancy time sharing, in accordance with the present disclosure.

FIG. 7 is a diagram illustrating an example process performed, for example, by a UE, in accordance with the present disclosure.

FIG. 8 is a diagram illustrating an example process performed, for example, by a UE, in accordance with the present disclosure.

FIG. 9 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

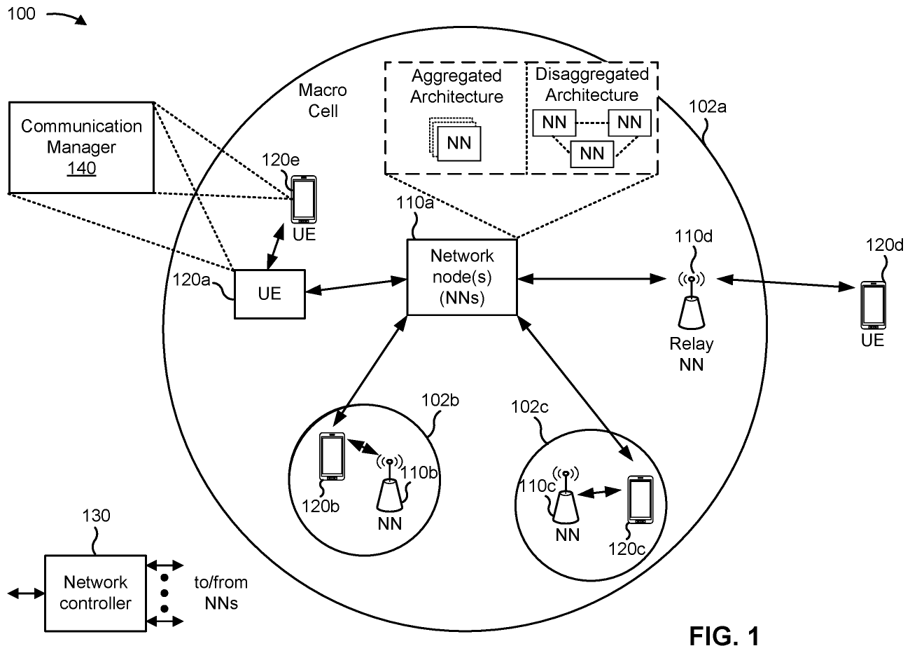

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IOT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FRI is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a first UE (e.g., a UE 120) may include a communication manager 140. As described in more detail elsewhere herein, the communication manager 140 may receive channel occupancy time (COT) system information (COT-SI) associated with a COT from a COT initiator. The communication manager 140 may transmit a physical sidelink feedback channel (PSFCH) communication on a channel during the COT based at least in part on a determination that the first UE is COT-sharing eligible based at least in part on a sidelink logical ID indicated in the COT-SI.

In some aspects, a second UE (e.g., a UE 120) may include a communication manager 140. As described in more detail elsewhere herein, the communication manager 140 may select a first UE that is eligible for COT sharing. The communication manager 140 may transmit COT-SI, associated with a COT, that includes a sidelink logical ID that is associated with the first UE. Additionally, or alternatively, the communication manager 140 may perform one or more other operations described herein.

As indicated above, FIG. 1 is provided as an example. Other examples may differ from what is described with regard to FIG. 1.

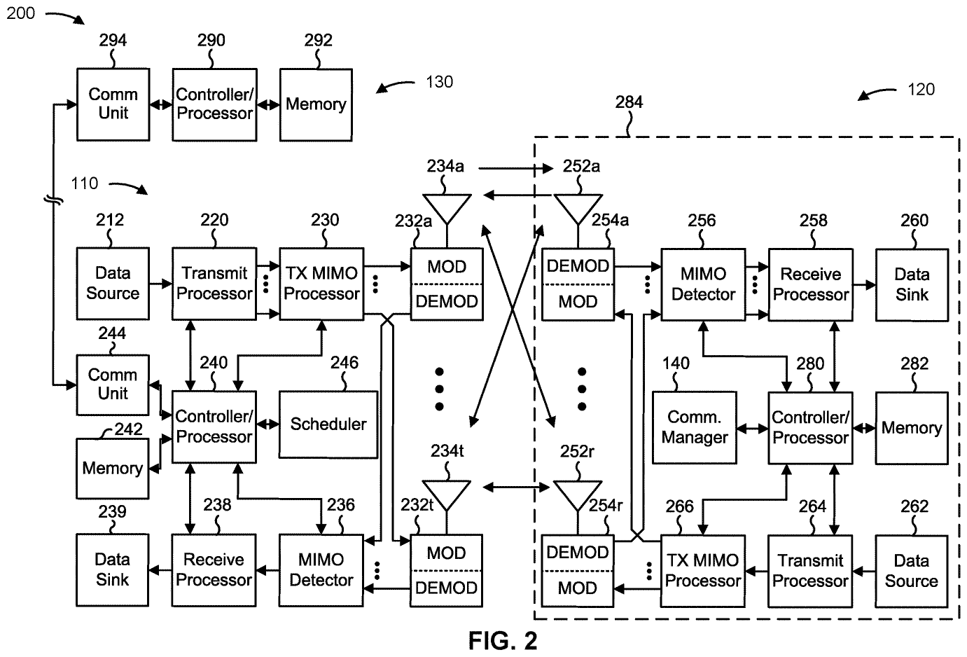

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., Toutput symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

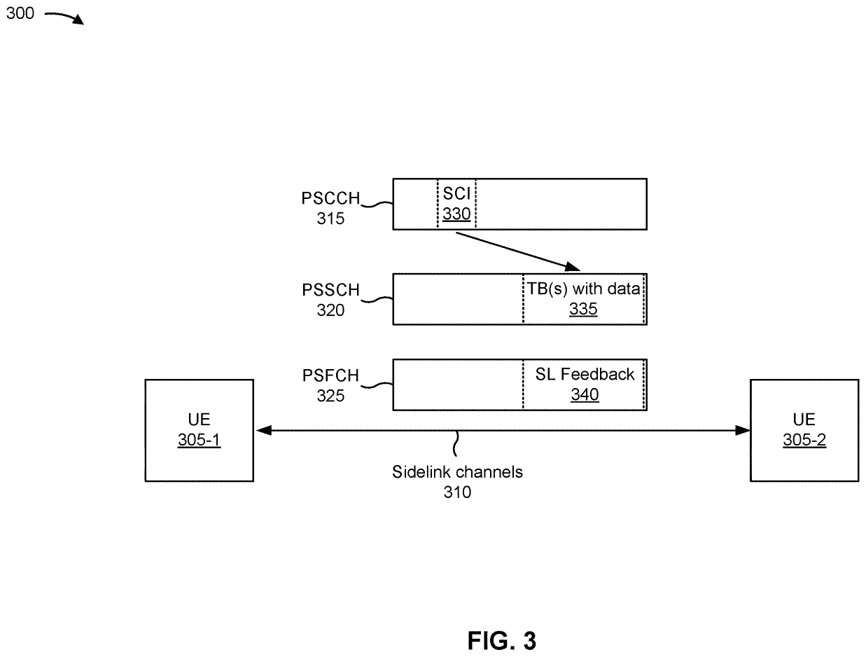

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-9).

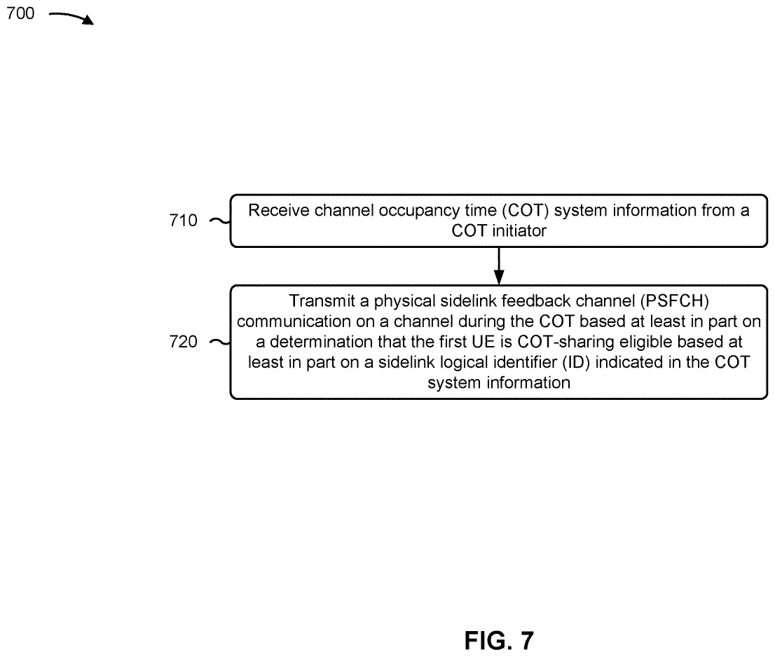

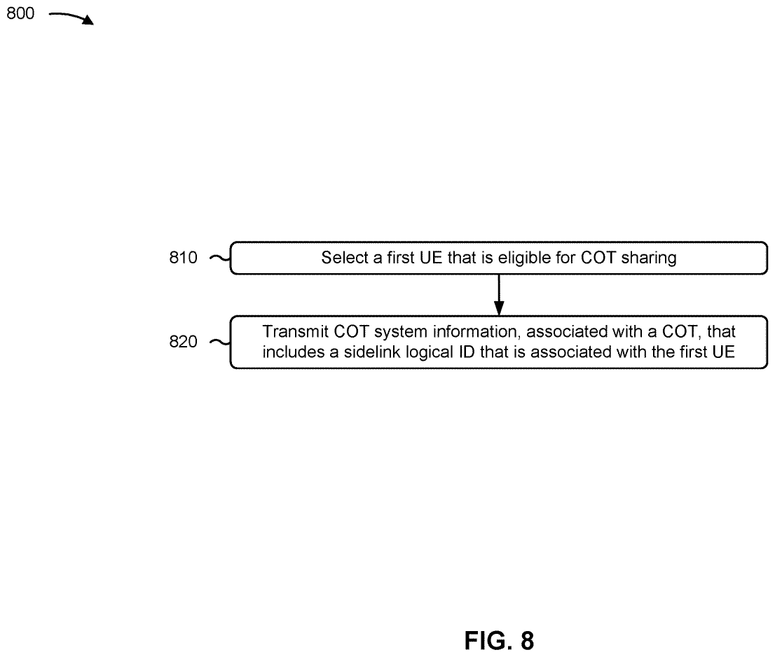

The controller/processor 240 of the network node 110, the controller/processor 280 of the UE 120, and/or any other component(s) of FIG. 2 may perform one or more techniques associated with determining COT sharing eligibility, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, a first UE (e.g., a UE 120) includes means for receiving COT-SI associated with a COT from a COT initiator; and/or means for transmitting a PSFCH communication on a channel during the COT based at least in part on a determination that the first UE is COT-sharing eligible based at least in part on a sidelink logical ID indicated in the COT-SI. The means for the first UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a second UE (e.g., a UE 120) includes means for selecting a first UE that is eligible for COT sharing; and/or means for transmitting COT-SI that includes a sidelink logical ID that is associated with the first UE. The means for the second UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a PSSCH 320, and/or a PSFCH 325. The PSCCH 315 may be used to communicate control information, similar to a physical downlink control channel (PDCCH) and/or a physical uplink control channel (PUCCH) used for cellular communications with a network node 110 via an access link or an access channel. The PSSCH 320 may be used to communicate data, similar to a physical downlink shared channel (PDSCH) and/or a physical uplink shared channel (PUSCH) used for cellular communications with a network node 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QOS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 320, such as a HARQ process ID, a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a sidelink transmission mode (e.g., Mode 1) where resource selection and/or scheduling is performed by a network node 110. For example, the UE 305 may receive a grant (e.g., in downlink control information (DCI) or in a radio resource control (RRC) message, such as for configured grants) from the network node 110 for sidelink channel access and/or scheduling. In some aspects, a UE 305 may operate using a transmission mode (e.g., Mode 2) where resource selection and/or scheduling is performed by the UE 305 (e.g., rather than a network node 110). In some aspects, the UE 305 may perform resource selection and/or scheduling by sensing channel availability for transmissions. For example, the UE 305 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy ratio (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or an MCS to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

A medium access command (MAC) protocol data unit (PDU) sub-header may include a source ID (e.g., 16 bit SRC) and a destination ID (e.g., 9 bit DST). SCI may include a 16 bit destination ID and an 8 bit source ID. If a TB is associated with unicast, the DST field of the decoded MAC PDU sub-header is equal to the 8 most significant bits (MSB) of any of the source Layer-2 ID(s) of the UE for which the 16 least significant bits (LSB) are equal to the destination ID in the corresponding SCI, and the SRC field of the decoded MAC PDU sub-header is equal to the 16 MSB of any of the destination Layer-2 ID(s) of the UE for which the 8 LSB are equal to the source ID in the corresponding SCI. For unicast, a receiver UE is expected to check both the source ID and the destination ID. If the TB is associated with groupcast or broadcast and the DST field of the decoded MAC PDU sub-header is equal to the 8 MSB of any of the destination Layer-2 ID(s) of the UE for which the 16 LSB are equal to the destination ID in the corresponding SCI, the receiver UE is expected to only check the destination ID.

As indicated above, FIG. 3 is provided as an example. Other examples may differ from what is described with respect to FIG. 3.

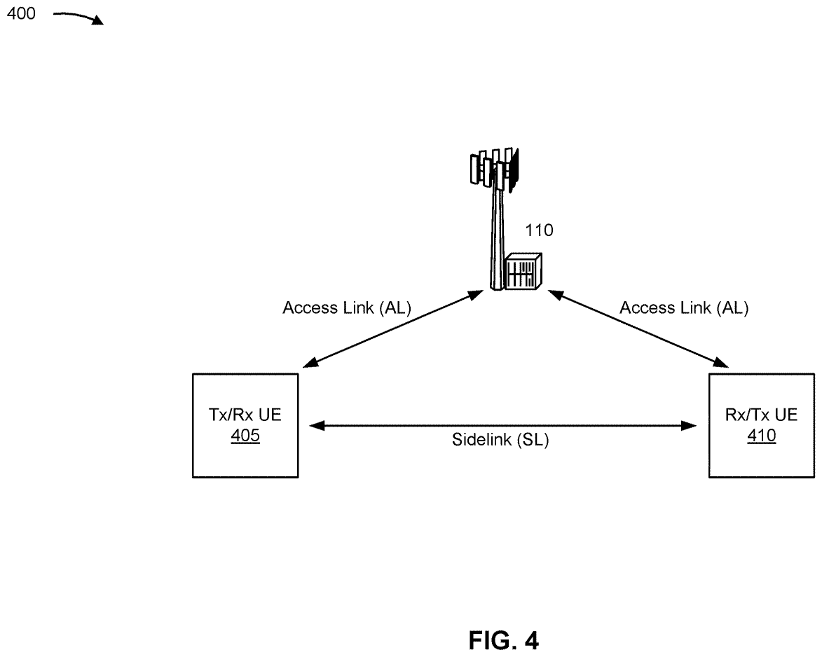

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a network node 110 may communicate with the Tx/Rx UE 405 via a first access link. Additionally, or alternatively, in some sidelink modes, the network node 110 may communicate with the Rx/Tx UE 410 via a second access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a network node 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

As indicated above, FIG. 4 is provided as an example. Other examples may differ from what is described with respect to FIG. 4.

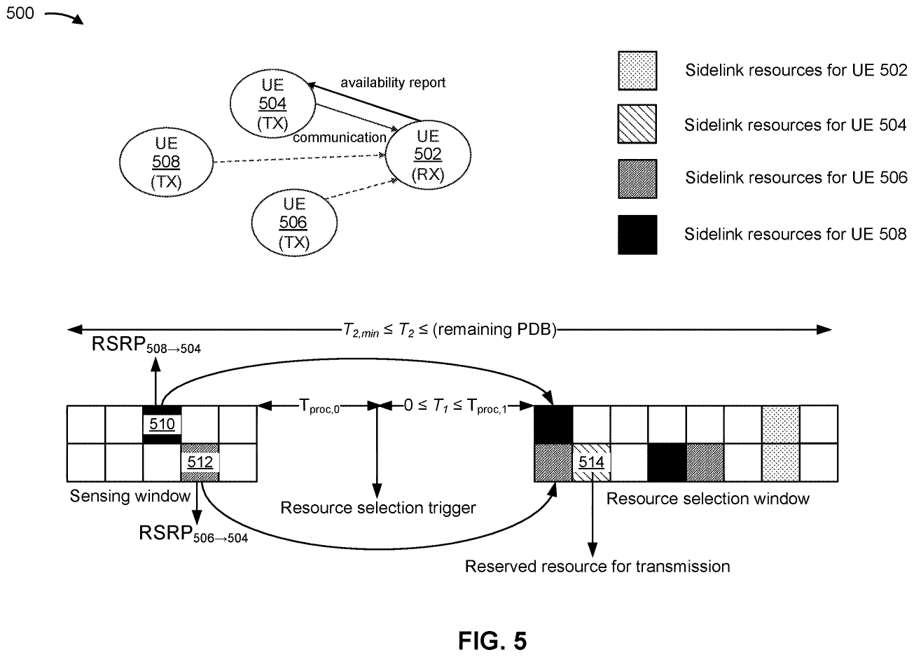

FIG. 5 is a diagram illustrating an example 500 of selecting sidelink resources, in accordance with the present disclosure. Example 500 shows a UE 502 (e.g., a UE 502) that may receive communications on a sidelink channel from other UEs, such as UE 504, UE 506, and/or UE 508.

As described in connection with FIG. 5, UE 504 is a transmitting UE that is transmitting communications to UE 502, which is a receiving UE. UE 504 may use a report from UE 502, which may act as a reporting UE that reports available sidelink resources, preferred sidelink resources, non-preferred sidelink resources, or sidelink resource conflicts. Example 500 shows an availability report from UE 502 to UE 504 and a communication from UE 504 to UE 502.

If UE 504 is to transmit a communication to UE 502, UE 504 may sense the sidelink channel in a sensing window to determine which sidelink resources (e.g., subcarriers, subchannels) are available. UE 504 may use a listen-before-talk (LBT) procedure to sense the channel. The LBT procedure maybe a type 1 LBT procedure, where UE 504 listens for multiple slots (e.g., 9 milliseconds (ms)) and uses a counter. A sidelink resource may be considered available if the sidelink resource was clear or had a signal energy (e.g., RSRP) that satisfied an availability threshold (e.g., measured interference or energy on the channel is lower than a maximum decibel-milliwatts (dBm) or dB, RSRP threshold). The availability threshold may be configured or preconfigured per transmission priority and receive priority pair. UE 504 may measure DMRSs on a PSCCH or a PSSCH, according to a configuration.

For example, UE 504 may prepare to transmit a communication to UE 502. UE 504 may have already sensed previous sidelink resources and successfully decoded SCI from UE 506 and UE 508. UE 504 may try to reserve sidelink resources, and thus may check the availability of the future sidelink resources reserved by UE 506 and UE 508 by sensing the sidelink channel in the sensing window. UE 504 may measure an RSRP of a signal from UE 508 in sidelink resource 510, and an RSRP of a signal from UE 506 in sidelink resource 512. If an observed RSRP (RSRP projection) satisfies the RSRP threshold (e.g., is lower than a maximum RSRP), the corresponding sidelink resource may be available for reservations by UE 504. UE 504 may reserve the sidelink resource (which may be a random selection from available resources). For example, UE 504 may select and reserve sidelink resource 514 for transmission. This may be in a time slot after which UE 506 and UE 508 had used sidelink resources, and UE 504 may have sensed these sidelink resources earlier. UE 504 may select and reserve sidelink resources only upon reaching a threshold level (e.g., 20%, 30%, or 50% availability). UE 504 may increase or decrease the RSRP threshold as necessary to arrive at the threshold level. UE 504 may select and reserve sidelink resources in the current slot and up to two (or more) future slots. Reservations may be aperiodic or periodic (e.g., SCI signals period between 0 ms and 1000 ms). Periodic resource reservation may be disabled.

There may be a resource selection trigger to trigger selection of sidelink resources after a processing time T_{proc,0}, and before another processing time T_{proc,1} before a resource selection window from which sidelink resources are available. The resource selection window may be a time window from which sidelink resources may be selected, and the resource selection window may extend for a remaining packet delay budget (PDB).

If UE 504 determines that a channel is clear, the UE 504 may treat the channel as clear for a maximum duration of time, or a COT. If UE 504 does not need to use the whole COT for transmission or reception, UE 504 may share the COT with another UE, such as with UE 502. UE 504 may indicate RBs and a time duration for the COT. UE 504 may be a COT initiator that performs an LBT procedure and starts the COT. UE 504 may transmit data to UE 502 in a PUSCH communication during the COT. UE 502 may be a COT responder and may provide a PSFCH communication to UE 504, in response to the PUSCH communication, during the COT. UE 502 may be considered to be a PSFCH transmitter. UE 502 may perform a type 2 LBT procedure, which is a “one-shot” channel sensing of a much shorter duration (e.g., 16 microseconds) than a duration of a type 1 LBT procedure.

If UE 502 wants to use a PSFCH symbol that is part (e.g., RB) of a shared COT, at least one PSFCH is expected to target the COT initiator. Currently the physical (PHY) layer has all of the COT related information (e.g., RB sets, duration, channel access priority classes) but has limited scope on the ID of the COT initiator, knowing only 8 bits in source ID SCI-2 field corresponding to the 8 LSBs of the 24 bits L2 ID associated with the sidelink session. Type 2 access, which is based only on Layer 1 (L1) IDs, is less reliable. Currently the MAC layer has the full Layer 2 (L2) logical IDs related to sidelink sessions and can reliably map a transmission to a (logical) destination. On the other side, the MAC layer is typically (e.g., for 3GPP standard Release 16 unlicensed NR (NR-U)) unaware of L1 information related to a COT. Such information may include COT sharing information (COT-SI) that indicates the RBs and time domain of the COT. In sum, while in NR-U the relations for COT sharing may be trivial (gNB-UE), in unlicensed sidelink (SL-U), COT sharing and channel access type may depend on IDs. Therefore, the segregation of necessary information in the MAC layer (full L2 IDs) and the PHY layer (COT information), respectively, may be an obstacle.

Another issue is related to how ID information for the PSFCH is handled. The IDs in the MAC/PHY layers are logical IDs (per session) and are not mapped to a specific device. This complicates the use of a shared COT across different transmissions. The PHY/MAC layers do not know if COT sharing is applicable to a PSFCH by decoding the COT-SI from other links or sessions.

One solution, in an example, is to determine if a TB over a PSSCH is eligible to be transmitted on a shared COT based on logical IDs contained in the initiator's transmission or a COT sharing ID (mapped to several logical IDs) contained in COT-SI. A COT responder may determine if the COT responder is a target of COT-SI by reading a known logical ID or a COT sharing ID. The COT responder may determine if the new TB can be transmitted if the COT responder ID matches one of the logical IDs found in the COT initiator's transmission or a logical ID mapped to the COT sharing ID found in the COT initiator's transmission. The COT sharing ID or the logical IDs may enable more targets, enable unicast or groupcast, or enable cross-session COT sharing.

For PSFCH, the COT responder may use a logical ID in the COT-SI, but there may need to be a PSFCH ID in order to determine eligibility of a PSFCH transmission to use a shared COT. This is a PHY layer transmission, and it is up to the PHY layer to decide to use the COT (e.g., based on a mapping of a resource and an L1 source ID in received SCI-2). Differently, for PSSCH, a MAC entity provides information to the PHY layer to populate the SCI, but with MAC to PHY communication, this information is not used for a PSFCH transmission.

There are at least three options for COT sharing eligibility. In a first option (Option 1), a PSFCH transmitter is addressed by a COT initiator (receiving PSSCH or PSSCH scheduling SCI for the PSFCH), and the PSFCH transmission burst contains at least one code division multiplexing (CDM) or frequency division multiplexing (FDM) PSFCH targeting COT initiator. In a second option (Option 2), the PSFCH transmitter is addressed by the COT initiator, and the PSFCH transmission could target any UE. In a third option (Option 3), the PSFCH transmitter is not addressed by the COT initiator but receives COT-SI, and the PSFCH transmission could target any UE. However, for the solutions and options described above, a COT responder (e.g., PSFCH transmitter) may expect further clarity as to whether the COT responder is eligible to share the COT.

As indicated above, FIG. 5 is provided as an example. Other examples may differ from what is described with regard to FIG. 5.

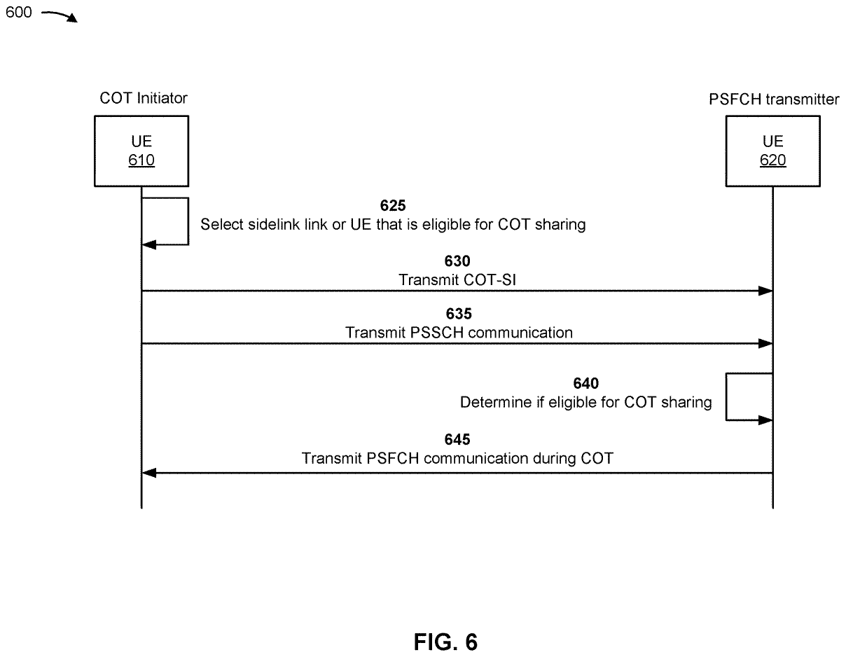

FIG. 6 is a diagram illustrating an example 600 associated with COT sharing, in accordance with the present disclosure. As shown in FIG. 6, a first UE 610 (e.g., a UE 120) and a second UE 620 (e.g., a UE 120) may communicate with one another via a sidelink. UE 610 may be a COT initiator, and UE 620 may be a COT responder or a PSFCH transmitter.

According to various aspects described herein, a PSFCH transmitter may receive COT-SI associated with a COT from a COT initiator and transmit a PSFCH communication on a channel during the COT, based at least in part on a sidelink logical identifier indicated in the COT-SI. As shown by reference number 625, UE 610 may select a sidelink link or a UE that is eligible for COT sharing. This may include a sidelink link between UE 610 and UE 620. Selecting a sidelink link may include selecting a destination UE for a sidelink link, such as selecting UE 620. As shown by reference number 630, UE 610, as the COT initiator, may transmit COT-SI, associated with a COT, to UE 620, as the PSFCH transmitter. The COT-SI may indicate the COT and may include a sidelink logical ID that UE 620 can use to determine if UE 620 is eligible to share the COT. The COT-SI may be addressed to UE 620 or may not be addressed to UE 620. As shown by reference number 635, UE 610 may transmit a PSSCH communication to UE 620.

As shown by reference number 630, the UE 640 may determine whether UE 620 is eligible to share the COT. This determination may be based at least in part on the sidelink logical ID included in the COT-SI and/or an ID (e.g., logical ID, destination ID, source ID, groupcast ID) provided in the PSSCH communication. In some aspects, the PSFCH transmitter may be eligible to share the COT and transmit a PSFCH communication in the COT if the PSFCH communication follows a data transmission in the time domain within a transmission burst that targets the COT initiator. That is, the PSFCH transmitter may be eligible for COT sharing if the PSFCH communication is attached to the data transmission, is within the same transmission burst as the data transmission, and the transmission burst targets the COT initiator. The transmission burst may include a PSCCH communication, a PSSCH communication, or a sidelink synchronization signal block (S-SSB). The COT-SI may address UE 620 or may not address UE 620. The PSFCH communication may be transmitted to any receiver, including the COT initiator and other receivers. If the PSFCH communication is attached to a data transmission that qualifies as Option 1 COT sharing, there is less harm to another RAT as the PSFCH communication is within the same transmission burst as the data transmission. Successfully using the COT reduces communication latency.

As shown by reference number 645, UE 620 may transmit the PSFCH communication on a channel during the COT. This may include performing a type 2 LBT procedure to determine if the channel is clear.

In some aspects, for UE 620 to qualify as a target of COT sharing, UE 620 may detect matching logical ID(s) (from the associated PSSCH communication) in the COT initiator's transmission. UE 620 may try to match the logical ID(s) from the associated PSSCH communication with a logical ID pair list given in the COT-SI. The logical ID pair list may include a source ID and a destination ID for each pair. The sidelink logical ID may be included in the logical ID pair list. The logical ID pair list may be associated with an additional field in the COT-SI. The additional field may include explicit logical IDs, or a COT sharing ID mapped to a set of logical IDs. The logical ID pair list may be for a unicast session or a groupcast session. UE 620 may try to match a destination ID (for unicast) or a groupcast ID (for groupcast) in the logical ID list included in the COT-SI. The IDs may be L1 IDs or L2 IDs. An L2 ID may use MAC PDU decoding and messaging from the MAC to the PHY and may be more accurate than an L1 ID.

For example, UE 620 may receive a PSSCH communication that includes a logical ID. UE 620 may determine COT sharing eligibility based at least in part on the logical ID matching the sidelink logical ID, which may be in the logical ID pair list. The sidelink logical ID may be a destination ID.

In some aspects, the logical ID and the sidelink logical ID may be groupcast IDs. If the PSFCH communication is in response to a groupcast PSSCH communication and the group destination ID from the associated PSSCH communication matches the sidelink logical ID found in the COT-SI (e.g., legacy logical IDs in SCI/MAC PDU, additional logical IDs found in COT-SI, or logical IDs mapped to COT sharing ID found in COT-SI), the PSFCH transmission may share the COT. The PSFCH communication, in response to the groupcast PSSCH communication, may be intended to be received by all members of the groupcast. UE 620 may select the PSFCH resources based at least in part on its ID within the PSFCH group, and the PSFCH may be received by any potential groupcast PSSCH transmitter within the PSFCH group. Therefore, as long as UE 610 is a member of the groupcast, UE 610 is a target receiver of the PSFCH communication.

In some aspects, UE 610 may include the groupcast IDs that UE 610 plans to address in the current COT in the logical ID list contained in the COT-SI. UE 620, with an associated groupcast PSSCH's groupcast ID matching one of the groupcast ID in the logical ID list would be the UE that UE 610 addresses. As UE 610 is a member of the addressed groupcast, the PSFCH communication may share the COT and no further step may be required. UE 620's determination of COT sharing eligibility may be related to UE behavior rather than just ID matching.

In some aspects, the logical ID in the PSSCH communication is a source ID, and the sidelink logical ID is a source ID. For unicast, to qualify for COT sharing (e.g., where UE 620 is addressed by UE 610 and at least one of the PSFCH communications from UE 620 is expected to be transmitted to UE 610 to qualify for the COT sharing), besides being a target of COT sharing, UE 620 may check if the source ID(s) of the associated PSSCH communication(s) matches the source ID in the logical ID pair list from the COT-SI or is mapped to a COT sharing ID in the COT-SI. For multiple PSFCH communications from one PSFCH transmitter, at least one of the source IDs of the associated PSSCH communications matches one of the source IDs in the logical ID pair list. The IDs may be L1 IDs or L2 IDs.

As indicated above, FIG. 6 is provided as an example. Other examples may differ from what is described with respect to FIG. 6.

FIG. 7 is a diagram illustrating an example process 700 performed, for example, by a UE, in accordance with the present disclosure. Example process 700 is an example where the UE (e.g., UE 120, UE 620) performs operations associated with COT sharing eligibility determination.

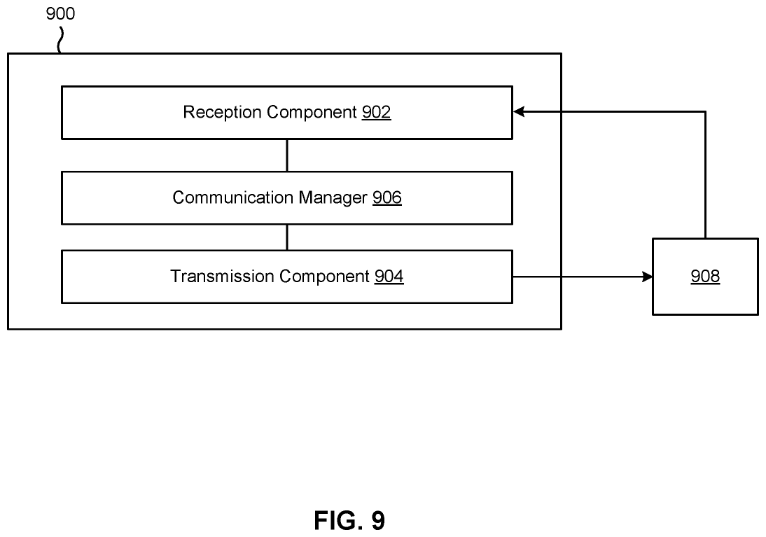

As shown in FIG. 7, in some aspects, process 700 may include receiving COT-SI associated with a COT from a COT initiator (block 710). For example, the UE (e.g., using reception component 902 and/or communication manager 906, depicted in FIG. 9) may receive COT-SI associated with a COT from a COT initiator, as described above.

As further shown in FIG. 7, in some aspects, process 700 may include transmitting a PSFCH communication on a channel during the COT based at least in part on a determination that the first UE is COT-sharing eligible based at least in part on a sidelink logical ID indicated in the COT-SI (block 720). For example, the UE (e.g., using transmission component 904 and/or communication manager 906, depicted in FIG. 9) may transmit a PSFCH communication on a channel during the COT based at least in part on a determination that the first UE is COT-sharing eligible based at least in part on a sidelink logical ID indicated in the COT-SI, as described above.

Process 700 may include additional aspects, such as any single aspect or any combination of aspects described below and/or in connection with one or more other processes described elsewhere herein.

In a first aspect, process 700 includes performing a type 2 LBT procedure on the channel, where transmitting the PSFCH communication includes transmitting the PSFCH communication based at least in part on a determination that the channel is clear.

In a second aspect, alone or in combination with the first aspect, the COT-SI addresses the first UE, process 700 includes determining that the first UE is COT-sharing eligible based at least in part on the PSFCH communication following a data transmission in a time domain within a transmission burst that targets the COT initiator, and transmitting the PSFCH communication includes transmitting the PSFCH communication to the COT initiator or another receiver.

In a third aspect, alone or in combination with one or more of the first and second aspects, the transmission burst includes a PSCCH communication, a PSSCH communication, or an S-SSB.

In a fourth aspect, alone or in combination with one or more of the first through third aspects, the COT-SI does not address the first UE, process 700 includes determining that the first UE is COT-sharing eligible based at least in part on the PSFCH communication following a data transmission in a time domain within a transmission burst that targets the COT initiator, and transmitting the PSFCH communication includes transmitting the PSFCH communication to the COT initiator or another receiver.

In a fifth aspect, alone or in combination with one or more of the first through fourth aspects, the sidelink logical ID is included in a logical ID pair list, and process 700 includes receiving a PSSCH communication that includes a logical ID, and determining that the first UE is COT-sharing eligible based at least in part on the logical ID matching the sidelink logical ID in the logical ID pair list.

In a sixth aspect, alone or in combination with one or more of the first through fifth aspects, the sidelink logical ID is a destination ID.

In a seventh aspect, alone or in combination with one or more of the first through sixth aspects, the logical ID pair list includes an L1 ID or an L2 ID.

In an eighth aspect, alone or in combination with one or more of the first through seventh aspects, the logical ID in the PSSCH communication is a groupcast ID, and the sidelink logical ID is the groupcast ID.

In a ninth aspect, alone or in combination with one or more of the first through eighth aspects, the sidelink logical ID is a source ID in a logical ID pair list, and process 700 includes receiving a PSSCH communication that includes a source ID, and determining that the first UE is COT-sharing eligible based at least in part on the source ID matching the sidelink logical ID in the logical ID pair list.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a UE, in accordance with the present disclosure. Example process 800 is an example where the UE (e.g., UE 120, UE 610) performs operations associated with determining COT sharing eligibility.

As shown in FIG. 8, in some aspects, process 800 may include selecting a first UE that is eligible for COT sharing (block 810). For example, the UE (e.g., using communication manager 906, depicted in FIG. 9) may select a first UE that is eligible for COT sharing, as described above.

As further shown in FIG. 8, in some aspects, process 800 may include transmitting COT-SI that includes a sidelink logical ID that is associated with the first UE (block 820). For example, the UE (e.g., using transmission component 904 and/or communication manager 906, depicted in FIG. 9) may transmit COT-SI, associated with a COT, that includes a sidelink logical ID that is associated with the first UE, as described above.

Process 800 may include additional aspects, such as any single aspect or any combination of aspects described below and/or in connection with one or more other processes described elsewhere herein.

In a first aspect, process 800 includes receiving a communication on a channel during the COT.

In a second aspect, alone or in combination with the first aspect, the second UE is a COT initiator.

In a third aspect, alone or in combination with one or more of the first and second aspects, the sidelink logical ID is included in a logical ID pair list, and process 800 includes transmitting a PSSCH communication that includes a logical ID.

In a fourth aspect, alone or in combination with one or more of the first through third aspects, the logical ID in the PSSCH communication is a destination ID, and the sidelink logical ID is the destination ID.

In a fifth aspect, alone or in combination with one or more of the first through fourth aspects, the logical ID pair list includes an L1 ID or an L2 ID.

In a sixth aspect, alone or in combination with one or more of the first through fifth aspects, the logical ID in the PSSCH communication is a groupcast ID, and the sidelink logical ID is the groupcast ID.

In a seventh aspect, alone or in combination with one or more of the first through sixth aspects, the sidelink logical ID is a source ID in a logical ID pair list, and process 800 includes transmitting a PSSCH communication that includes a source ID.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE (e.g., UE 120, UE 610, UE 620), or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 140 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 1-6. Additionally, or alternatively, the apparatus 900 may be configured to perform one or more processes described herein, such as process 700 of FIG. 7, process 800 of FIG. 8, or a combination thereof. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

In some aspects associated with a first UE (e.g., PSFCH transmitter), the reception component 902 may receive COT-SI associated with a COT from a COT initiator. The transmission component 904 may transmit a PSFCH communication on a channel during the COT based at least in part on a determination that the first UE is COT-sharing eligible based at least in part on a sidelink logical ID indicated in the COT-SI.

The communication manager 906 may perform a type 2 LBT procedure on the channel, and the transmission component 904 may transmit the PSFCH communication based at least in part on a determination that the channel is clear.

In some aspects associated with a second UE (e.g., COT initiator), the communication manager 906 may select a fist UE that is eligible for COT sharing. The transmission component 904 may transmit COT-SI, associated with a COT, that includes a sidelink logical ID that is associated with the first UE. The reception component 902 may receive a communication on a channel during the COT.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components.

Additionally, or alternatively, a set of (one or more) components shown in FIG. 9 may perform one or more functions described as being performed by another set of components shown in FIG. 9.

The following provides an overview of some Aspects of the present disclosure:
Aspect 1: A method of wireless communication performed by a first user equipment (UE), comprising: receiving channel occupancy time (COT) system information associated with a COT from a COT initiator; and transmitting a physical sidelink feedback channel (PSFCH) communication on a channel during the COT based at least in part on a determination that the first UE is COT-sharing eligible based at least in part on a sidelink logical identifier (ID) indicated in the COT-SI.
Aspect 2: The method of Aspect 1, further comprising performing a type 2 listen-before-talk procedure on the channel, wherein transmitting the PSFCH communication includes transmitting the PSFCH communication based at least in part on a determination that the channel is clear.
Aspect 3: The method of Aspect 1 or 2, wherein the COT-SI addresses the first UE, wherein the method includes determining that the first UE is COT-sharing eligible based at least in part on the PSFCH communication following a data transmission in a time domain within a transmission burst that targets the COT initiator, and wherein transmitting the PSFCH communication includes transmitting the PSFCH communication to the COT initiator or another receiver.
Aspect 4: The method of Aspect 3, wherein the transmission burst includes a physical sidelink control channel communication, a physical sidelink shared channel communication, or a sidelink synchronization signal block.
Aspect 5: The method of Aspect 1 or 2, wherein the COT system information does not address the first UE, wherein the method includes determining that the first UE is COT-sharing eligible based at least in part on the PSFCH communication following a data transmission in a time domain within a transmission burst that targets the COT initiator, and wherein transmitting the PSFCH communication includes transmitting the PSFCH communication to the COT initiator or another receiver.
Aspect 6: The method of any of Aspects 1-5, wherein the sidelink logical ID is included in a logical ID pair list, and wherein the method includes: receiving a physical sidelink shared channel (PSSCH) communication that includes a logical ID; and determining that the first UE is COT-sharing eligible based at least in part on the logical ID matching the sidelink logical ID in the logical ID pair list.
Aspect 7: The method of Aspect 6, wherein the sidelink logical ID is a destination ID.
Aspect 8: The method of Aspect 6, wherein the logical ID pair list includes a Layer 1 ID or a Layer 2 ID.
Aspect 9: The method of Aspect 6, wherein the logical ID in the PSSCH communication is a groupcast ID, and wherein the sidelink logical ID is the groupcast ID.
Aspect 10: The method of any of Aspects 1-9, wherein the sidelink logical ID is a source ID in a logical ID pair list, and wherein the method includes: receiving a physical sidelink shared channel (PSSCH) communication that includes a source ID; and determining that the first UE is COT-sharing eligible based at least in part on the source ID matching the sidelink logical ID in the logical ID pair list.
Aspect 11: A method of wireless communication performed by a second user equipment (UE), comprising: selecting a first UE that is eligible for channel occupancy time (COT) sharing; and transmitting COT system information that includes a sidelink logical identifier (ID) that is associated with the first UE.
Aspect 12: The method of Aspect 11, further comprising receiving a communication on a channel during the COT.
Aspect 13: The method of any of Aspects 11-12, wherein the second UE is a COT initiator.
Aspect 14: The method of any of Aspects 11-13, wherein the sidelink logical ID is included in a logical ID pair list, and wherein the method includes transmitting a physical sidelink shared channel (PSSCH) communication that includes a logical ID.
Aspect 15: The method of Aspect 14, wherein the logical ID in the PSSCH communication is a destination ID, and wherein the sidelink logical ID is the destination ID.
Aspect 16: The method of Aspect 14, wherein the logical ID pair list includes a Layer 1 ID or a Layer 2 ID.
Aspect 17: The method of Aspect 14, wherein the logical ID in the PSSCH communication is a groupcast ID, and wherein the sidelink logical ID is the groupcast ID.
Aspect 18: The method of any of Aspects 11-17, wherein the sidelink logical ID is a source ID in a logical ID pair list, and wherein the method includes transmitting a physical sidelink shared channel (PSSCH) communication that includes a source ID.
Aspect 19: An apparatus for wireless communication at a device, comprising a processor; memory coupled with the processor; and instructions stored in the memory and executable by the processor to cause the apparatus to perform the method of one or more of Aspects 1-18.
Aspect 20: A device for wireless communication, comprising a memory and one or more processors coupled to the memory, the one or more processors configured to perform the method of one or more of Aspects 1-18.
Aspect 21: An apparatus for wireless communication, comprising at least one means for performing the method of one or more of Aspects 1-18.
Aspect 22: A non-transitory computer-readable medium storing code for wireless communication, the code comprising instructions executable by a processor to perform the method of one or more of Aspects 1-18.
Aspect 23: A non-transitory computer-readable medium storing a set of instructions for wireless communication, the set of instructions comprising one or more instructions that, when executed by one or more processors of a device, cause the device to perform the method of one or more of Aspects 1-18.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A first user equipment (UE) for wireless communication, comprising:
one or more memories; and
one or more processors, coupled to the one or more memories, configured to:
receive channel occupancy time (COT) system information associated with a COT from a COT initiator; and
transmit a physical sidelink feedback channel (PSFCH) communication on a channel during the COT based at least in part on a determination that the first UE is COT-sharing eligible based at least in part on a sidelink logical identifier (ID) indicated in the COT system information.

2. The first UE of claim 1, wherein the one or more processors are configured to perform a type 2 listen-before-talk procedure on the channel, wherein the one or more processors, to transmit the PSFCH communication, are configured to transmit the PSFCH communication based at least in part on a determination that the channel is clear.

3. The first UE of claim 1, wherein the COT system information addresses the first UE, wherein the one or more processors are configured to determine that the first UE is COT-sharing eligible based at least in part on the PSFCH communication following a data transmission in a time domain within a transmission burst that targets the COT initiator, and wherein the one or more processors, to transmit the PSFCH communication, are configured to transmit the PSFCH communication to the COT initiator or another receiver.

4. The first UE of claim 3, wherein the transmission burst includes a physical sidelink control channel communication, a physical sidelink shared channel communication, or a sidelink synchronization signal block.

5. The first UE of claim 1, wherein the COT system information does not address the first UE, wherein the one or more processors are configured to determine that the first UE is COT-sharing eligible based at least in part on the PSFCH communication following a data transmission in a time domain within a transmission burst that targets the COT initiator, and wherein the one or more processors, to transmit the PSFCH communication, are configured to transmit the PSFCH communication to the COT initiator or another receiver.

6. The first UE of claim 1, wherein the sidelink logical ID is included in a logical ID pair list, and wherein the one or more processors are configured to:
receive a physical side link shared channel (PSSCH) communication that includes a logical ID; and
determine that the first UE is COT-sharing eligible based at least in part on the logical ID matching the sidelink logical ID in the logical ID pair list.

7. The first UE of claim 6, wherein the sidelink logical ID is a destination ID.

8. The first UE of claim 6, wherein the logical ID pair list includes a Layer 1 ID or a Layer 2 ID.

9. The first UE of claim 6, wherein the logical ID in the PSSCH communication is a groupcast ID, and wherein the sidelink logical ID is the groupcast ID.

10. The first UE of claim 1, wherein the sidelink logical ID is a source ID in a logical ID pair list, and wherein the one or more processors are configured to:
receive a physical side link shared channel (PSSCH) communication that includes a source ID; and
determine that the first UE is COT-sharing eligible based at least in part on the source ID matching the sidelink logical ID in the logical ID pair list.

11. A second user equipment (UE) for wireless communication, comprising:
one or more memories; and
one or more processors, coupled to the one or more memories, configured to:
select a first UE that is eligible for channel occupancy time (COT) sharing; and transmit COT system information, associated with a COT, that includes a sidelink logical identifier (ID) that is associated with the first UE.

12. The second UE of claim 11, wherein the one or more processors are configured to receive a communication on a channel during the COT.

13. The second UE of claim 11, wherein the second UE is a COT initiator.

14. The second UE of claim 11, wherein the sidelink logical ID is included in a logical ID pair list, and wherein the one or more processors are configured to transmit a physical sidelink shared channel (PSSCH) communication that includes a logical ID.

15. The second UE of claim 14, wherein the logical ID in the PSSCH communication includes a destination ID, and wherein the sidelink logical ID includes the destination ID.

16. The second UE of claim 14, wherein the logical ID pair list includes a Layer 1 ID or a Layer 2 ID.

17. The second UE of claim 14, wherein the logical ID in the PSSCH communication is a groupcast ID, and wherein the sidelink logical ID is the groupcast ID.

18. The second UE of claim 11, wherein the sidelink logical ID is a source ID in a logical ID pair list, and wherein the one or more processors are configured to transmit a physical sidelink shared channel (PSSCH) communication that includes a source ID.

19. A method of wireless communication performed by a first user equipment (UE), comprising:
receiving channel occupancy time (COT) system information associated with a COT from a COT initiator; and
transmitting a physical sidelink feedback channel (PSFCH) communication on a channel during the COT based at least in part on a determination that the first UE is COT-sharing eligible based at least in part on a sidelink logical identifier (ID) indicated in the COT system information.

20. The method of claim 19, wherein the COT system information addresses the first UE, wherein the method includes determining that the first UE is COT-sharing eligible based at least in part on the PSFCH communication following a data transmission in a time domain within a transmission burst that targets the COT initiator, and wherein transmitting the PSFCH communication includes transmitting the PSFCH communication to the COT initiator or another receiver.

21-30. (canceled)
